(19) United States
(12) Patent Application Publication
(10) Pub. No.: US 2017/0004277 A1
(43) Pub. Date: Jan. 5, 2017

(54) Method and non-transitory computer-readable computer program product for identification of effective drugs

(71) Applicant: Szegedi Tudományegyetem, Szeged (HU)

(72) Inventors: Máté Manczinger, Szeged (HU); Lajos Kemény, Szeged (HU)

(21) Appl. No.: 15/198,366

(22) Filed: Jun. 30, 2016

Related U.S. Application Data
(60) Provisional application No. 62/188,509, filed on Jul. 3, 2015.

(51) Int. Cl. G06F 19/00; G06F 17/50

(52) U.S. Cl. CPC G06F 19/3437; G06F 17/5009

(57) ABSTRACT

A method and a non-transitory computer-readable computer program product for identification of effective drugs. The object is to provide a computer simulation method for modelling flow in intracellular networks at lesional and non-lesional disease states and to find potentially effective drugs for specific diseases. The method involves modelling an intracellular network by a network of nodes and directed edges between the nodes, where each node corresponds to any one of protein and DNA, and each edge corresponds to the directed interaction between two nodes.

This application claims priority to U.S. provisional application Ser. No. 62/188,509, filed Jul. 3, 2015.

### FIELD OF THE INVENTION

The present invention relates to a method and a non-transitory computer-readable computer program product for identification of effective drugs.

### BACKGROUND ART

Modelling intracellular networks is becoming an important challenge in bioinformatics. Different methods are currently available. For example, Yeh et al. “A network flow approach to predict drug targets from microarray data, disease genes and interactome network—case study on prostate cancer” (Journal on Clinical Bioinformatics 2: 1, 2012) discloses the simulation of the spread of information in a system, thus modelling network information flow.

Another challenge is to process the already huge amount of data generated in systems biology and systems pharmacology. Identification of basic principles in such enormous data exceeds the capacity of the human brain, thus the use of machine learning is inevitable. Tarca et al. (PLoS Comput Biol 3: e116, 2007) reviewed machine learning methods available for biology. One of the most widely used learning algorithms is Support Vector Machine (SVM), which constructs a model from training samples (i.e. network flow simulation data of effective drugs) and solves classification tasks using this model (effective vs. non-effective drugs). This learning algorithm is described, for example, in Hua et al. “Support vector machine approach for protein subcellular localization prediction” (Bioinformatics 17: 721-728, 2001).

The object of the present invention is to provide a computer simulation method for modelling flow in intracellular networks at lesional and non-lesional disease states and to find potentially effective drugs for specific diseases.

### SUMMARY OF THE INVENTION

In a first aspect, the invention relates to a method of identifying an efficient drug for treating a disease. The method comprising the steps of:
a) modelling an intracellular network by a network of nodes and directed edges between the nodes, wherein each node corresponds to any one of protein and DNA, and each edge corresponds to the directed interaction between two nodes,
b) assigning a basal activity level to each node having a predetermined default value according to the healthy state of the respective protein or DNA and added to each node's actual activity before each step,
c) associating an activity flow with each edge; the activity flow for an edge directed from node “a” to node “b” during one step being defined by the following equation:

$${I}_{a , b} = \frac{{w}_{a , b} {m}_{a , b} ( {x}_{a} + {c}_{a} )}{{\sum }_{i = 0}^{n} {w}_{a , i}} ,$$

where a is a source node, b is a target node, w_{a,b} is the weight of the interaction (positive real number), m_{a,b} is the action of the interaction (in case of activation m=1, whereas in case of inhibition m=−1), xₐ is the activity of the source node a before the actual step, c is the basal activity of the source node a, and n is the number of interactions (i.e. edges) originating from node a in the modelled network,
d) simulating the stepwise propagation of the activity within the network starting from an initial state, in which all of the nodes have their basal value for the actual activity level, and terminating in an equilibrium state, in which the changes of the actual activities of the nodes between two subsequent simulation steps decrease below a predetermined threshold, thereby generating a first set of actual activity levels of nodes corresponding to the healthy state of the intracellular network,
e) adjusting the basal activity level of nodes according to a diseased state of the respective protein or DNA,
f) simulating the stepwise propagation of the activity within the network starting from actual activity levels reached in step d), using adjusted value for the basal activity level, and terminating in an equilibrium state, in which the changes of the activities of the nodes between two subsequent simulation steps decrease below a predetermined threshold, thereby generating a second set of actual activity levels of nodes corresponding to a disease state of the intracellular network,
g) adjusting the basal activity level of nodes according to the effect of a selected drug,
h) simulating the stepwise propagation of the activity within the network starting from actual activity levels reached in step f), using basal activity levels of diseased state, but modified according to drug effect, and terminating in an equilibrium state, in which the changes of the activities of the nodes between two subsequent simulation steps decrease below a predetermined threshold, thereby generating a third set of actual activity levels of nodes corresponding to the effect of the selected drug to the intracellular network,
i) repeating steps g) and h) with the selection of further dugs and using modified basal activity levels of nodes according to drug effects, thereby generating further drug-specific sets of actual activity levels of nodes corresponding to the effects of the further selected drugs to the intracellular network,
j) using actual activity values calculated for drugs, which are already known to be effective in the treatment of disease for the training of support vector machine (SVM) and, thus, generating several different SVM models using different parameters,
k) repeating whole process of drug effect simulation (steps g-i) with different drug efficacy levels and generate SVM models using actual activity levels calculated for effective drugs (step j),
l) make SVM predictions for drugs, which are not used for the treatment of the given disease based on models generated during SVM training processes, and
m) qualifying a drug, which is not yet being used in the treatment of disease as effective, if it is predicted in most high accuracy SVM predictions as effective.

In a second aspect, the invention relates to a non-transitory computer program product comprising computer-readable instructions which, when executed on a computer, cause the computer to carry out the steps of the method according to the invention.

### BRIEF DESCRIPTION OF THE DRAWINGS

The invention will now be described through a preferred embodiment with reference to the accompanying drawings, in which

FIG. 1 is a flow diagram showing the steps of the method of the invention,

FIG. 2 illustrates an example of information flow in a simplified network in one step of the method according to the present invention,

FIG. 3 illustrates the efficiency of specific drugs in in vitro experiments, wherein the drugs are selected as a result of carrying out the computer simulation method according to the present invention, and

FIGS. 4 and 5 illustrate the efficiency of the selected drugs in in vivo experiments.

### DETAILED DESCRIPTION OF THE INVENTION

First, some of the terms related to the method and commonly used throughout the present specification are defined below.

Step: A virtual and non-defined amount of time, which is needed for the diffusion of total actual activity from one node to the connected nodes.

Diffusion matrix: A matrix which contains actual activity values. Its columns represent steps and its rows represent nodes.

Basal activity: An activity, which is added to the actual node activity levels before each step. Basal activity level is proportional with gene expression or protein levels and can be modulated by drugs.

Actual activity: Total activity level (i.e. the sum of the basal activity level and the inflow) of each node at the end of the actual step.

Activity: A virtual value representing capability of a node acting on other nodes (it can be proportional with the amount of protein/DNA, node degree within the network etc.)

Prediction: A computational “decision making” carried out by a SVM based on a model constructed also by the SVM during a training process.

Training: Based on the diffusion matrices calculated for the drugs known to be effective for the disease, SVM constructs a model for prediction.

SVM model: A collection of functions created during an SVM training process and needed for a classification (prediction) process. The network used for flow simulation includes nodes and directed edges between the nodes, wherein each node corresponds to any one of protein and DNA molecule, and each edge corresponds to a directed interaction between two nodes.

The algorithm used by the method of the invention calculates the actual state of a node (i.e. activity) in a stepwise manner. All nodes have a basal activity added to its actual activity before the next step. One step is the same for all nodes and equals the diffusion of total actual activity from one node to the connected nodes.

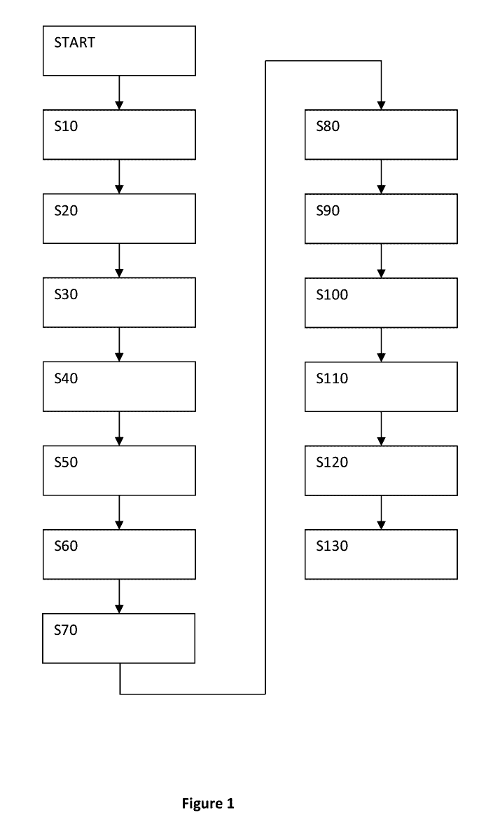

FIG. 1 depicts a flow diagram showing the main steps of the method according to the present invention. In the first step S10 of the method, an intracellular network is modelled by a network of nodes and directed edges between the nodes, wherein each node corresponds to any one of protein and DNA, and each edge corresponds to the directed interaction between two nodes. Next, in step S20, a basal activity level is assigned to each node having a predetermined default value according to the healthy state of the respective protein or DNA and added to each node's actual activity before each simulation step.

In step S30, an activity flowing from one node to another one is associated with each edge, wherein the activity flowing from one node “a” to another node “b” in one simulation step is defined by the following equation:

$${I}_{a , b} = \frac{{w}_{a , b} {m}_{a , b} ( {x}_{a} + {c}_{a} )}{{\sum }_{i = 0}^{n} {w}_{a , i}} ,$$

where a is a source node, b is a target node, w_{a,b} is the weight of the interaction (positive real number), m_{a,b} is the action of the interaction (in case of activation: m=1, whereas in case of inhibition: m=−1), xₐ is the activity of the source node a before the actual step, c is the basal activity of the source node a, and n is the number of interactions (i.e. edges) originating from node a in the simulation model.

When the simulation model is ready to run, the next step S40 comprises simulating the stepwise propagation of the activity within the network starting from an initial state, in which all of the nodes have their basal value for the actual activity level, and terminating in an equilibrium state, in which the changes of the actual activities of the nodes between two subsequent simulation steps decrease below a predetermined threshold, thereby generating a first set of actual activity levels for the nodes corresponding to the healthy state of the intracellular network.

In the next step S50, the basal activity level is adjusted for each node according to a diseased state of the respective protein or DNA.

In step S60, the stepwise propagation of the activity within the network is simulated with starting from actual activity levels reached in step S40, using an adjusted value for the basal activity level, and with terminating in an equilibrium state, in which the changes of the activities of the nodes between two subsequent simulation steps decrease below a predetermined threshold, thereby generating a second set of actual activity levels of nodes corresponding to a disease state of the intracellular network.

Next, the basal activity level of nodes is adjusted according to the effect of a selected drug in step S70 and then the stepwise propagation of the activity within the network is simulated in step S80 with starting from the actual activity levels reached in step S60, using the basal activity levels of diseased state, but modified according to the drug's effect, and with terminating in an equilibrium state, in which the changes of the activities of the nodes between two subsequent simulation steps decrease below a predetermined threshold, thereby generating a third set of actual activity levels of nodes corresponding to the effect of the selected drug to the intracellular network.

The above mentioned steps 70 and 80 of the method are repeated in step 90 with selecting further drugs and using modified basal activity levels of nodes according to drug effects, thereby generating further drug-specific sets of actual activity levels of nodes corresponding to the effects of the further selected drugs to the intracellular network.

Next, in step S100, the actual activity values calculated for those drugs are used, which are already known to be effective in the treatment of disease for the training of a support vector machine (SVM), thereby generating several different SVM models using different parameters.

Then in step S110, the whole process of drug effect simulation (steps S70 to S90) is repeated with different drug efficacy levels and various SVM models are generated using actual activity levels calculated for effective drugs (step S100).

After completing the simulation of drug effect, in step S120 SVM predictions are made for those drugs which are not used for the treatment of the given disease based on models generated during SVM training processes.

Finally, in step S130, a drug which has not been used in the treatment of the disease as an effective drug is qualified as an effective drug if it is predicted to be effective by most high-accuracy SVM models.

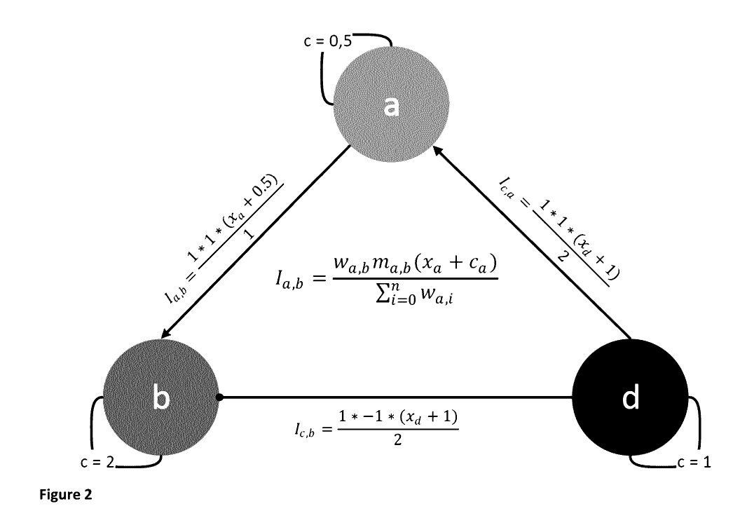

FIG. 2 illustrates an example of information flow in one step for a simplified network consisting of 3 nodes. Node “b” has a basal activity of 2 as it represents a protein coded by upregulated gene in lesional skin compared to non-lesional. Node “a” has a basal activity of 0.5 as it is coded by downregulated gene and node “d” has a basal activity of 1 as its expression doesn't change.

The algorithm creates a so called diffusion matrix, where rows represent nodes and columns represent the actual activity of the nodes. For carrying out the simulation, a specific software may be developed, for example in R language, that models the spread of information in a given intracellular network with a fast and effective spreading algorithm.

If a given network contains only activating interactions, the total activity increases step by step as the basal activity is added to each node in the beginning of steps. A dynamic equilibrium evolves if the network contains enough inhibiting interactions, as activity of several nodes is used for decreasing the activity of other ones. Preferably, the activity flow may be simulated until reaching the dynamic equilibrium.

In a preferred embodiment of the method according to the invention, the following scheme for the identification of effective drugs may be used:
a) Reliable databases for the construction of protein-protein and protein-DNA interaction networks are used. A preferred database for the construction of protein-protein interaction networks is the “Search Tool for Recurring Instances of Neighbouring Genes” (STRING) database (see Szklarczyk et al. “The STRING database in 2011: functional interaction networks of proteins, globally integrated and scored”, Nucleic Acids Res 39: D561-568, 2011).
b) In the first stage of the simulation, spreading of the activity within the simulation network is simulated starting from an initial state, in which all of the nodes have its default value for the basal activity level, and terminating in a dynamic equilibrium state, in which the changes of the activities of the nodes between two subsequent simulation steps decrease below a predetermined threshold. As a result of the first simulation stage, a first set of actual activity levels of nodes corresponding to the healthy state of the intracellular network is generated.
c) Then in the second stage of the simulation, the basal activity values of all nodes are adjusted to reflect a “disease” state (for example we duplicate basal activity for nodes having increased expression and bisect basal activity for nodes with decreased expression) The simulation starts from actual activity levels reached in first stage and each of the nodes have its default or disease-adjusted value for the basal activity level. The simulation terminates in an equilibrium state, in which the changes of the activities of the nodes between two subsequent simulation steps decrease below a predetermined threshold. Thereby a second set of activity levels of nodes corresponding to a disease state of the intracellular network is generated.

In the third stage of simulation, the basal activity level of nodes is further adjusted according to the effect of a selected drug, while the basal activity level of other nodes are kept unchanged. In this simulation stage, the spreading of the activity within the simulation network is simulated with starting form actual activity levels reached in second stage, and terminating in an equilibrium state, in which the changes of the activities of the nodes between two subsequent simulation steps decrease below a predetermined threshold. As a result of this drug effect simulation, a result set of activity levels of nodes corresponding to the effect of the selected drug to the intracellular network is generated. In this third stage of simulation, for the simulation of drug effects on the network, a reliable drug-target database is preferably used (e.g. Drugbank, see Law et al. “DrugBank 4.0: shedding new light on drug metabolism”, Nucleic Acids Res 42: D1091-1097, 2014).
d) Effective drug identification may be carried out using a SVM library, for example LIBSVM (see Chang et al., “LIBSVM: A Library for Support Vector Machines”, Acm Transactions on Intelligent Systems and Technology 2, 2011).
e) For training SVM, it is preferred to use the diffusion matrices of drugs which are indicated in the treatment of the disease. Information about drug indications can be found for example in FDA “Drug Label Database” (https://rm2.scinet.fda.gov/druglabel#simsearch-0). The “one-class” SVM method may be used, when the simulation has the purpose of identifying one group of drugs (i.e. effective drugs) and not to differentiate between two groups. SVM may be executed with linear and polynomial kernels, and in case of polynomial kernels, functions with different degrees can be fitted.

All SVM training may be preceded with data scaling and parameter optimization, which is done with at least 2-fold cross-validation. Then the models with the highest (but at least 50%) cross-validation accuracy may be further used for prediction.

All SVM training and prediction may also be carried out with reduced dimensions as well. Principal component analysis (PCA) may be used for dimension reduction, which may also be integrated into the simulation software. Dimensions are preferably reduced so that the loss of variance is less than 1%.

A drug is considered to be effective if it is found to be effective in most high-accuracy prediction models. Drug effects with different rate of activation and inhibition are to be simulated and the results of all predictions may be used to determine drug efficacy in the treatment of the disease.

The method according to the present invention is suitable for the identification of drugs which are potentially effective in a given disease. The simulation model and the algorithm used therein, however, are also suitable for modelling other, non-biological networks as well, and simulated data can be processed with machine learning.

### EXAMPLE

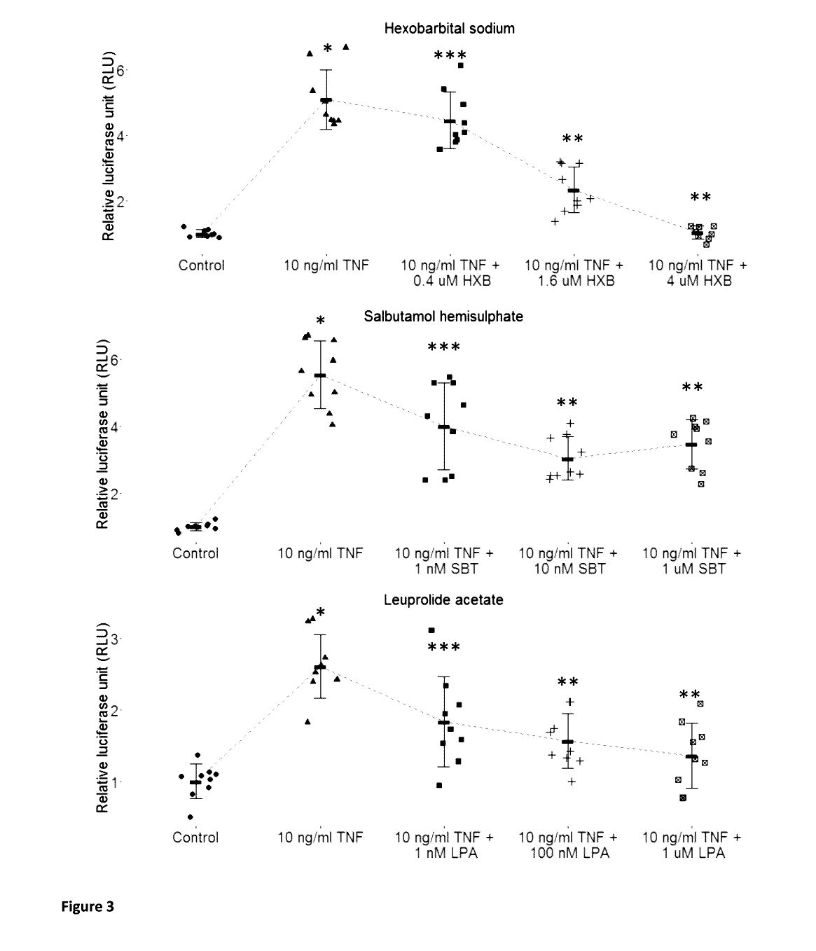

Hereinafter an example is introduced with reference to FIGS. 3 to 5 to demonstrate how to use the method of the invention to identify efficient drugs in the treatment of psoriasis.

The STRING 9.0 database was used for the network construction. Directed interactions with a known action (i.e. activation or inhibition) and a high confidence score were collected.

A flow simulation was run until equilibrium with a default node basal activity level value of 1. The equilibrium was defined as the point where the total activity change in the system is less than 1% between two subsequent simulation steps.

The basal activity level values for the “disease” state of the simulation network were adjusted according to the results of an available microarray meta-analysis study carried out previously: nodes with upregulated protein-coding genes in lesional psoriatic skin compared to non-lesional were set to an activity value of 2. At the same time, nodes with downregulated protein-coding genes were set to an activity value of 0.5. These parameters can be seen in the simplified model shown in FIG. 2. The spreading of the activity within the network was simulated until equilibrium.

Drug targets and drug effects (activation or inhibition) were collected from Drugbank database. Data for 1440 drugs were used in the test.

Diffusion matrices of drugs indicated for the treatment of psoriasis in FDA “Drug Label Database” were used for training SVM. As described above, multiple predictions were made with different drug activities, SVM kernels and with reduced and non-reduced dimensions. A drug was considered to be efficient if it was found to be effective in most high-accuracy (>50%) SVM models.

Numerous potentially effective drugs in the treatment of psoriasis were identified by using the method of the invention. Three of them were selected, namely hexobarbital-sodium (HXB), salbutamol-hemisulphate (SBT) and leuprolide-acetate (LPA), and then in vitro and in vivo validation were carried out to prove their efficacy.

We used HPV-keratinocyte cell line transfected with a vector encoding NFkB promoter-controlled luciferase gene. Activity of luciferase gene and, thus, resultant luminescence is proportional with the induction of NFkB. The relation between NFkB and TNF is important in the induction and steady-state of psoriasis (see Young et al. “Reactive oxygen species in tumor necrosis factor-alpha-activated primary human keratinocytes: implications for psoriasis and inflammatory skin disease”, Journal on Invest Dermatology 128: 2606-2614, 2008). TNF induces NFkB, which then upregulates TNF forming a positive feedback loop. As it can be seen in FIG. 3, all predicted drugs significantly inhibited the TNF-dependent induction of NFKB (which is proportional with the measured luminescence) in HPV-keratinocytes. Data are presented as means ±SD*p<0.001 vs. Control group **p<0.001 vs. 10 ng/ml TNF group, ***p<0.01 vs. 10 ng/ml TNF group, n=9; HXB: hexobarbital sodium, SBT: salbutamol hemisulphate, LPA: leuprolide acetate.

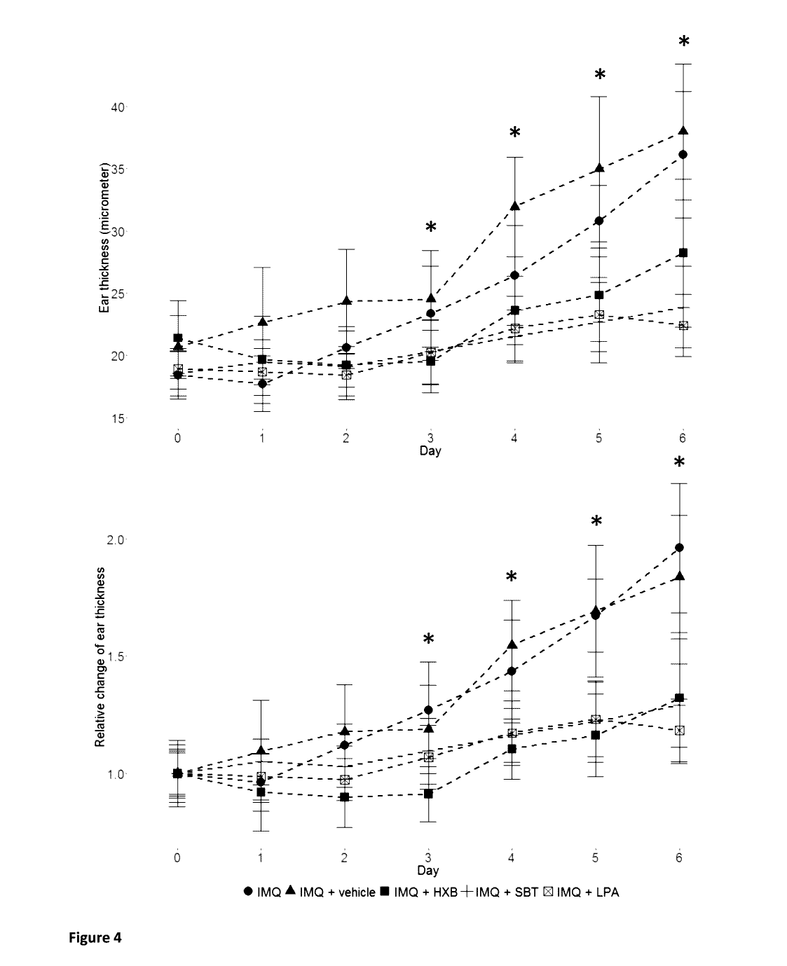

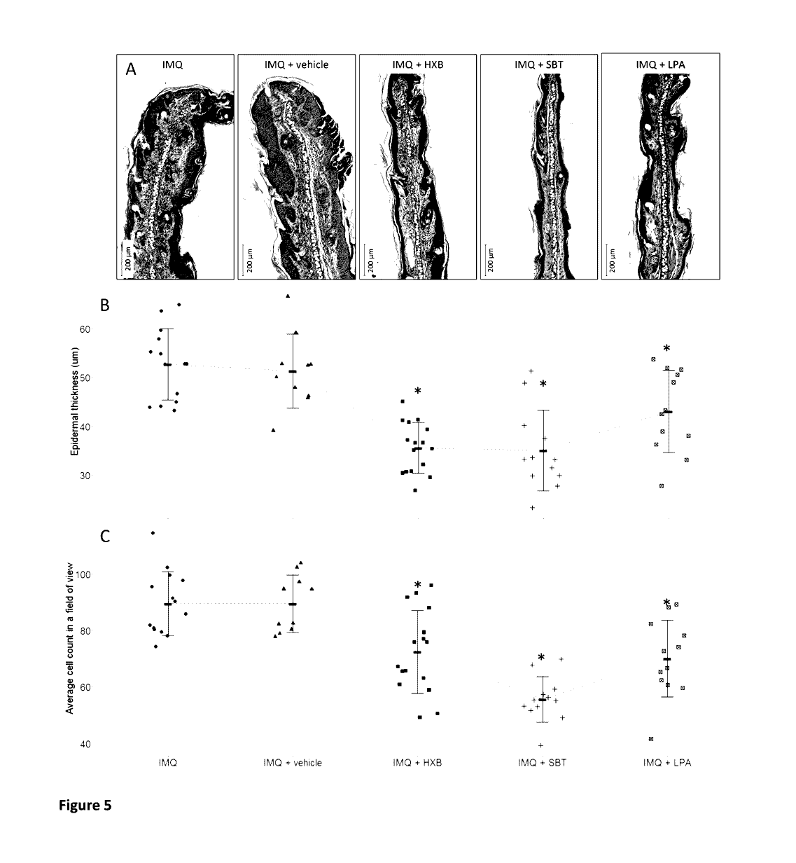

Next the efficacy of the selected drugs was assessed in vivo. Imiquimod-induced skin inflammation is a conventional model of psoriasiform dermatitis (see van der Fits et al “Imiquimod-induced psoriasis-like skin inflammation in mice is mediated via the IL-23/IL-17 axis”, Journal on Immunology 182: 5836-5845, 2009). Mice were treated with imiquimod for six days with 1) imiquimod (positive control), 2) imiquimod and gels containing drugs, and 3) imiquimod and vehicle (gel without drug). The results indicated that all three drugs significantly decreased ear thickening and cellular infiltration as shown in FIGS. 4 and 5.

FIG. 4 illustrate that all predicted drugs significantly inhibited IMQ-induced ear thickening of mice. The first diagram show the ear thickness values in μm on treatment days and the second diagram shows the relative changes of the thickness of ears measured on treatment days. In the latter case, all measured values are normalized with the group-specific mean thickness value on day 0. Data are presented as means ±SD*p<0.05 vs. IMQ and IMQ+vehicle groups, n≧10, HXB: hexobarbital sodium, SBT: salbutamol hemisulphate, LPA: leuprolide acetate.

FIG. 5 illustrates the in vivo results of histologic examination of ear specimens after 6 days of treatment. The images in series ‘A’ show characteristic microscopic pictures from each treatment group. The plot diagrams in series ‘B’ and ‘C’ illustrate that all three predicted drugs significantly decreased the thickening of epidermis and cellular infiltration. Data are presented as mean ±SD*p<0.05, n≧10, HXB: hexobarbital sodium, SBT: salbutamol hemisulphate, LPA: leuprolide acetate.

The present invention also relates, in a second aspect, to a computer program product comprising computer-readable instructions which, when executed on a computer, cause the computer to carry out the steps of the above described method of the invention.

1. A method of identifying an efficient drug for treating a disease, the method comprises of the following steps:
n) modelling an intracellular network by a network of nodes and directed edges between the nodes, wherein each node corresponds to any one of protein and DNA, and each edge corresponds to the directed interaction between two nodes,
o) assigning a basal activity level to each node having a predetermined default value according to the healthy state of the respective protein or DNA and added to each node's actual activity before each step,
p) associating an activity flow with each edge; the activity flow for an edge directed from node “a” to node “b” during one step being defined by the following equation:
$${I}_{a , b} = \frac{{w}_{a , b} {m}_{a , b} ( {x}_{a} + {c}_{a} )}{{\sum }_{i = 0}^{n} {w}_{a , i}} ,$$
where a is a source node, b is a target node, w_{a,b} is the weight of the interaction (positive real number), m_{a,b} is the action of the interaction (in case of activation m=1, whereas in case of inhibition m=−1), xₐ is the activity of the source node a before the actual step, c is the basal activity of the source node a, and n is the number of interactions (i.e. edges) originating from node a in the modelled network,
q) simulating the step wise propagation of the activity within the network starting from an initial state, in which all of the nodes have their basal value for the actual activity level, and terminating in an equilibrium state, in which the changes of the actual activities of the nodes between two subsequent simulation steps decrease below a predetermined threshold, thereby generating a first set of actual activity levels of nodes corresponding to the healthy state of the intracellular network,
r) adjusting the basal activity level of nodes according to a diseased state of the respective protein or DNA,
s) simulating the stepwise propagation of the activity within the network starting from actual activity levels reached in step d), using adjusted value for the basal activity level, and terminating in an equilibrium state, in which the changes of the activities of the nodes between two subsequent simulation steps decrease below a predetermined threshold, thereby generating a second set of actual activity levels of nodes corresponding to a disease state of the intracellular network,
t) adjusting the basal activity level of nodes according to the effect of a selected drug,
u) simulating the stepwise propagation of the activity within the network starting from actual activity levels reached in step f), using basal activity levels of diseased state, but modified according to drug effect, and terminating in an equilibrium state, in which the changes of the activities of the nodes between two subsequent simulation steps decrease below a predetermined threshold, thereby generating a third set of actual activity levels of nodes corresponding to the effect of the selected drug to the intracellular network,
v) repeating steps g) and h) with the selection of further dugs and using modified basal activity levels of nodes according to drug effects, thereby generating further drug-specific sets of actual activity levels of nodes corresponding to the effects of the further selected drugs to the intracellular network,
w) using actual activity values calculated for drugs, which are already known to be effective in the treatment of disease for the training of support vector machine (SVM) and, thus, generating several different SVM models using different parameters,
x) repeating whole process of drug effect simulation (steps g-i) with different drug efficacy levels and generate SVM models using actual activity levels calculated for effective drugs (step j),
y) make SVM predictions for drugs, which are not used for the treatment of the given disease based on models generated during SVM training processes, and
z) qualifying a drug, which is not yet being used in the treatment of disease as effective, if it is predicted in most high accuracy SVM predictions as effective.

2. A non-transitory computer program product comprising computer-readable instructions which, when executed on a computer, cause the computer to carry out the steps of the method of claim 1.
